(19) United States
(12) Patent Application Publication
(10) Pub. No.: US 2022/0303605 A1
(43) Pub. Date: Sep. 22, 2022

(54) METHOD FOR SWITCHING LIVE-STREAMING ROOMS AND ELECTRONIC DEVICE

(71) Applicant: BEIJING DAJIA INTERNET INFORMATION TECHNOLOGY CO., LTD., Beijing (CN)

(72) Inventor: Yao ZHANG, Beijing (CN)

(21) Appl. No.: 17/836,410

(22) Filed: Jun. 9, 2022

Related U.S. Application Data
(63) Continuation of application No. PCT/CN2020/116902, filed on Sep. 22, 2020.

(30) Foreign Application Priority Data
Dec. 24, 2019 (CN) 201911349333.4

(51) Int. Cl. H04N 21/262; H04N 21/2187; H04N 21/6377; H04N 21/258; H04N 21/482

(52) U.S. Cl. CPC H04N 21/26258; H04N 21/2187; H04N 21/6377; H04N 21/25891; H04N 21/4826

(57) ABSTRACT

A method for switching live-streaming rooms is provided. The method includes: acquiring a live-streaming recommendation list; pushing the live-streaming recommendation list to a target client; receiving a live-streaming room switch instruction from the target client, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and sending a video stream corresponding to the second live-streaming room to the target client based on the live-streaming room switch instruction and the live-streaming room identification of the second live-streaming room.

### CROSS-REFERENCE TO RELATED APPLICATION

This application is a continuation application of International Application No. PCT/CN2020/116902, filed on Sep. 22, 2020, which claims the priority of Chinese Application No. 201911349333.4, filed on Dec. 24, 2019, both of which are incorporated by reference herein.

### TECHNICAL FIELD

The present disclosure relates to the field of Internet technologies, and in particular, relates to a method for switching live-streaming rooms and an electronic device.

### BACKGROUND

Live-streaming recommendation is to determine a type of anchor that a user likes based on information such as browsing, like, and gift-giving records, and a list of followed anchors of the user, search current live-streaming that the user may like based on the determined type of anchor, and then recommend the searched live-streaming to a terminal of the user.

### SUMMARY

The present disclosure provides a method for switching live-streaming rooms and an electronic device. The technical solutions of the present disclosure are as follows.

According to an aspect of an embodiment of the present disclosure, there is provided a method for switching live-streaming rooms. The method is executable by a server and includes:

acquiring a live-streaming recommendation list, wherein the live-streaming recommendation list includes a plurality of live-streaming room identifications;

pushing the live-streaming recommendation list to a target client, wherein the target client is configured to display the live-streaming recommendation list in a first live-streaming room;

receiving a live-streaming room switch instruction from the target client, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and

sending a video stream corresponding to the second live-streaming room to the target client based on the live-streaming room switch instruction and the live-streaming room identification corresponding to the second live-streaming room.

According to another aspect of an embodiment of the present disclosure, there is provided a method for switching live-streaming rooms. The method includes:

receiving a live-streaming recommendation list, wherein the live-streaming recommendation list includes a plurality of live-streaming room identifications;

displaying the live-streaming recommendation list in a first live-streaming room;

sending a live-streaming room switch instruction to a server, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and

receiving a video stream corresponding to the second live-streaming room from the server, and switching the first live-streaming room to the second live-streaming room based on the video stream.

According to yet another aspect of an embodiment of the present disclosure, there is provided an apparatus for switching live-streaming rooms. The apparatus includes:

a first acquiring module configured to acquire a live-streaming recommendation list, wherein the live-streaming recommendation list includes a plurality of live-streaming room identifications;

a pushing module configured to push the live-streaming recommendation list to a target client, wherein the target client is configured to display the live-streaming recommendation list in a first live-streaming room;

a first receiving module configured to receive a live-streaming room switch instruction from the target client, wherein the live-streaming room switch instruction carries a live-streaming room identification corresponding to a second live-streaming room, and the live-streaming room identification of the second live-streaming room is a live-streaming room identification triggered in the live-streaming recommendation list; and

a first sending module configured to send a video stream corresponding to the second live-streaming room to the target client based on the live-streaming room switch instruction and the live-streaming mom identification corresponding to the second live-streaming room.

According to yet another aspect of an embodiment of the present disclosure, there is provided an apparatus for switching live-streaming rooms. The apparatus includes:

a second receiving module configured to receive a live-streaming recommendation list, wherein the live-streaming recommendation list includes a plurality of live-streaming mom identifications;

a displaying module configured to display the live-streaming recommendation list in a first live-streaming room:

a second sending module configured to send a live-streaming room switch instruction to a server, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and

a live-streaming room switching module configured to receive a video stream corresponding to the second live-streaming room from the server, and switch the first live-streaming room to the second live-streaming room based on the video stream.

According to yet another aspect of an embodiment of the present disclosure, there is provided a server. The server includes:

one or more processors and a memory configured to store one or more instructions executable by the one or more processors.

wherein the one or more processors, when executing the one or more instructions, are caused to perform:

acquiring a live-streaming recommendation list, wherein the live-streaming recommendation list includes a plurality of live-streaming room identifications;

pushing the live-streaming recommendation list to a target client, wherein the target client is configured to display the live-streaming recommendation list in a first live-streaming room;

receiving a live-streaming room switch instruction from the target client, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and

sending a video stream corresponding to the second live-streaming room to the target client based on the live-streaming room switch instruction and the live-streaming room identification corresponding to the second live-streaming room.

According to yet another aspect of an embodiment of the present disclosure, there is provided a client. The client includes:

one or more processors and a memory configured to store one or more instructions executable by the one or more processors,

wherein the one or more processors, when executing the one or more instructions, are caused to perform:

receiving a live-streaming recommendation list, wherein the live-streaming recommendation list includes a plurality of live-streaming room identifications;

displaying the live-streaming recommendation list in a first live-streaming room;

sending a live-streaming room switch instruction to a server, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and

receiving a video stream corresponding to the second live-streaming room from the server, and switching the first live-streaming room to the second live-streaming room based on the video stream.

According to yet another aspect of an embodiment of the present disclosure, there is provided a non-transitory computer-readable storage medium. In response to execution of instructions in the storage medium by a processor of a server, the server is enabled to the perform the following steps:

acquiring a live-streaming recommendation list, wherein the live-streaming recommendation list includes a plurality of live-streaming room identifications;

pushing the live-streaming recommendation list to a target client, wherein the target client is configured to display the live-streaming recommendation list in a first live-streaming room;

receiving a live-streaming room switch instruction from the target client, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and

sending a video stream corresponding to the second live-streaming room to the target client based on the live-streaming room switch instruction and the live-streaming room identification corresponding to the second live-streaming room.

According to yet another aspect of an embodiment of the present disclosure, there is provided a non-transitory computer-readable storage medium. In response to execution of instructions in the storage medium by a processor of a client, the client is enabled to the perform the following steps:

receiving a live-streaming recommendation list, wherein the live-streaming recommendation list includes a plurality of live-streaming room identifications;

displaying the live-streaming recommendation list in a first live-streaming room;

sending a live-streaming room switch instruction to a server, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and

receiving a video stream corresponding to the second live-streaming room from the server, and switching the first live-streaming room to the second live-streaming room based on the video stream.

According to yet another aspect of an embodiment of the present disclosure, there is provided a computer program product including a computer program. The computer program is stored in a non-transitory computer-readable storage medium. At least one processor of a server reads the computer program from the non-transitory computer-readable storage medium and executes the same, such that the server is enabled to the perform the following steps:

acquiring a live-streaming recommendation list, wherein the live-streaming recommendation list includes a plurality of live-streaming room identifications;

pushing the live-streaming recommendation list to a target client, wherein the target client is configured to display the live-streaming recommendation list in a first live-streaming room;

receiving a live-streaming room switch instruction from the target client, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and

sending a video stream corresponding to the second live-streaming room to the target client based on the live-streaming room switch instruction and the live-streaming room identification corresponding to the second live-streaming room.

According to yet another aspect of an embodiment of the present disclosure, there is provided a computer program product including a computer program. The computer program is stored in a non-transitory computer-readable storage medium. At least one processor of a client reads the computer program from the non-transitory computer-readable storage medium and executes the same, such that the client is enabled to the perform the following steps:

receiving a live-streaming recommendation list, wherein the live-streaming recommendation list includes a plurality of live-streaming room identifications;

displaying the live-streaming recommendation list in a first live-streaming room;

sending a live-streaming room switch instruction to a server, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and

receiving a video stream corresponding to the second live-streaming room from the server, and switching the first live-streaming room to the second live-streaming room based on the video stream.

It should be understood that the above general descriptions and the following detailed descriptions are only exemplary and illustrative, and cannot limit the present disclosure.

### BRIEF DESCRIPTION OF THE DRAWINGS

The drawings herein are incorporated into the description, constitute a part of the description, show embodiments conforming to the present disclosure, are used to explain the principle of the present disclosure together with the description, and do not constitute an improper limitation of the present disclosure.

FIG. 1 is a schematic diagram of an implementation environment of a method for switching live-streaming rooms according to some embodiments of the present disclosure:

FIG. 2 is a diagram of an internal structure of a target client according to some embodiments of the present disclosure;

FIG. 3 is a diagram of an internal structure of a server according to some embodiments of the present disclosure;

FIG. 4 is a schematic flowchart of a method for switching live-streaming rooms according to some embodiments of the present disclosure;

FIG. 5 is a schematic flowchart of generating a live-streaming recommendation list according to some embodiments of the present disclosure;

FIG. 6 is a schematic flowchart of generating a live-streaming index according to some embodiments of the present disclosure;

FIG. 7 is a schematic diagram of displaying relevant information of a live-streaming room in a sidebar according to some embodiments of the present disclosure;

FIG. 8 is a schematic flowchart of a method for switching live-streaming rooms according to some embodiments of the present disclosure;

FIG. 9 is a schematic flowchart of a method for switching live-streaming rooms according to some embodiments of the present disclosure;

FIG. 10 is a structural block diagram of an apparatus for switching live-streaming moms according to some embodiments of the present disclosure; and

FIG. 11 is a structural block diagram of an apparatus for switching live-streaming rooms according to some embodiments of the present disclosure.

### DETAILED DESCRIPTION

In order to make those skilled in the art understand the technical solutions of the present disclosure better, the technical solutions in the embodiments of the present disclosure are clearly and completely described in the following with reference to the accompanying drawings.

It is to be noted that terms “first”, “second”, and the like in the description and claims, as well as the above accompanying drawings, of the present disclosure are used for the purpose of distinguishing similar objects instead of indicating a particular order or sequence. It should be understood that data used in this way are interchangeable where appropriate, such that the embodiments of the present disclosure described herein can be implemented in a sequence other than those illustrated or described herein. The implementations set forth in the following description of some embodiments do not represent all implementations consistent with the present disclosure. Instead, they are merely examples of apparatuses and methods consistent with aspects related to the present disclosure as recited in the appended claims.

In the related art, live-streaming recommendation is mainly to distribute live-streaming in a live-streaming square. A backend service sends live-streaming of a type of anchor who is liked by a user in the live-streaming square, such that the user can switch to a live-streaming room in which the user is interested. However, according to this technology, the user needs to exit from the current live-streaming room to the live-streaming square for browsing again to view recommended live-streaming and then switch live-streaming rooms. The operation is complex.

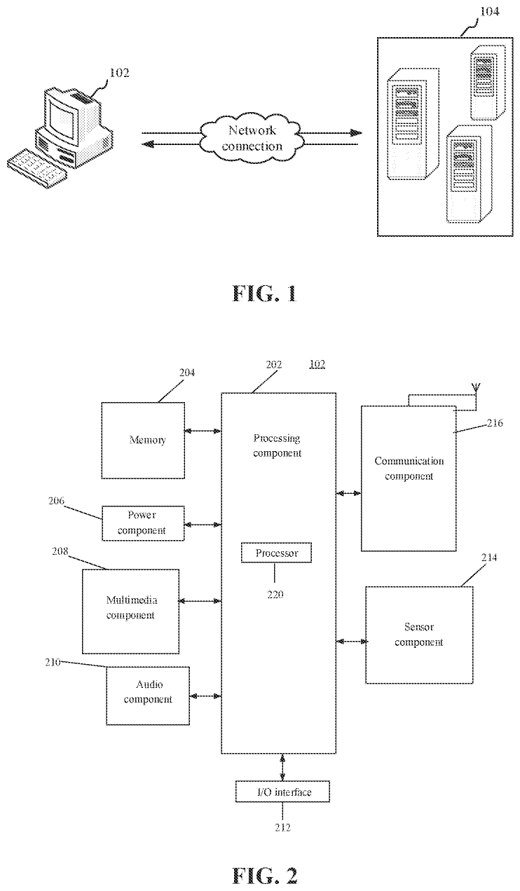

A method for switching live-streaming rooms provided in the present disclosure is applicable to an implementation environment shown in FIG. 1. The implementation environment includes a target client 102 and a server 104. The target client 102 communicates with the server 104 over a network. The target client 102 receives a live-streaming list acquisition instruction triggered by a user, and sends the live-streaming list acquisition instruction to the server 104. The server 104 acquires a live-streaming recommendation list based on the live-streaming list acquisition instruction, where the live-streaming recommendation list includes a plurality of live-streaming room identifications and live-streaming room information corresponding to each of the live-streaming room identifications. The server 104 sends the live-streaming recommendation list to the target client 102, such that the target client 102 displays the live-streaming recommendation list in a preset position of a first live-streaming room. The target client 102 generates a live-streaming room switch instruction based on a switch operation, and sends the live-streaming room switch instruction to the server 104. The server 104 receives the live-streaming room switch instruction from the target client, where the live-streaming room switch instruction carries a live-streaming room identification corresponding to a second live-streaming room, and the live-streaming room identification corresponding to the second live-streaming room is a live-streaming room identification triggered in the live-streaming recommendation list. The server 104 sends a video stream corresponding to the second live-streaming room to the target client 102 based on the live-streaming room identification corresponding to the second live-streaming room, such that the target client 102 switches the first live-streaming room to the second live-streaming room based on the video stream corresponding to the second live-streaming room. The target client 102 includes, but is not limited to, various personal computers, notebook computers, smartphones, tablet computers, portable wearable devices, digital broadcast terminals, message transceiving devices, gaming consoles, medical devices, fitness devices, and personal digital assistants. The server 104 is implemented by a standalone server or a server cluster composed of a plurality of servers.

FIG. 2 is a block diagram of a target client 102 for switching live-streaming rooms according to some embodiments of the present disclosure. Referring to FIG. 2, the target client 102 includes one or more of the following components: a processing component 202, a memory 204, a power component 206, a multimedia component 208, an audio component 210, an input/output (I/O) interface 212, a sensor component 214, and a communication component 216.

The processing component 202 typically controls overall operations of the target client 102, such as operations associated with display, phone calls, data communications, camera operations, and recording operations. The processing component 202 may include one or more processors 220 for executing instructions to perform all or part of the steps in the above-described methods. Moreover, the processing component 202 may include one or more modules that facilitate the interaction between the processing component 202 and other components. For instance, the processing component 202 may include a multimedia module to facilitate the interaction between the multimedia component 208 and the processing component 202.

The memory 204 is configured to store various types of data to support the operation of the target client 102. Examples of such data include instructions for any applications or methods operated on the target client 102, contact data, phonebook data, messages, pictures, video, etc. The memory 204 may be implemented using any type of transitory or non-transitory memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 206 provides power to various components of the target client 102. The power component 206 may include a power management system, one or more power sources, and any other components associated with the generation, management, and distribution of power in the target client 102.

The multimedia component 208 includes a screen providing an output interface between the target client 102 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 208 includes a front camera and/or a rear camera. The front camera and/or the rear camera may receive an external multimedia datum while the target client 102 is in an operation mode, such as a photographing mode or a video mode. Each of the front camera and the rear camera may be a fixed optical lens system or have focus and optical zoom capability.

The audio component 210 is configured to output and/or input audio signals. For example, the audio component 210 includes a microphone (MIC) configured to receive an external audio signal when the target client 102 is in an operation mode, such as a call mode, a recording mode, and a voice recognition mode. The received audio signal may be further stored in the memory 204 or transmitted via the communication component 216. In some embodiments, the audio component 210 further includes a speaker to output audio signals.

The I/O interface 212 provides an interface between the processing component 202 and peripheral interface modules, such as a keyboard, a click wheel, buttons, and the like. The buttons may include, but are not limited to, a home button, a volume button, a starting button, and a locking button.

The sensor component 214 includes one or more sensors to provide status assessments of various aspects of the target client 102. For instance, the sensor component 214 may detect an open/closed status of the target client 102, relative positioning of components, e.g., the display and the keypad of the target client 102, a change in position of the target client 102 or a component of the target client 102, a presence or absence of user contact with the target client 102, an orientation or an acceleration/deceleration of the target client 102, and a change in temperature of the target client 102. The sensor component 214 may include a proximity sensor configured to detect the presence of nearby objects without any physical contact. The sensor component 214 may also include a light sensor, such as a complementary metal-oxide-semiconductor (CMOS) or charge-coupled device (CCD) image sensor, for use in imaging applications. In some embodiments, the sensor component 214 may also include an accelerometer sensor, a gyroscope sensor, a magnetic sensor, a force sensor, or a temperature sensor.

The communication component 216 is configured to facilitate communication, wired or wirelessly, between the target client 102 and other devices. In embodiments of the present disclosure, the target client 102 can access a wireless network based on a communication standard, such as Wi-Fi, 2G, 3G, 4G, 5G or a combination thereof. In some embodiments, the communication component 216 receives a broadcast signal or broadcast associated information from an external broadcast management system via a broadcast channel. In some embodiments, the communication component 216 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the target client 102 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods for switching live-streaming rooms.

In some embodiments, there is also provided a non-transitory computer-readable storage medium including instructions, such as the memory 204 including instructions which are executable by the processor 220 in the target client 102 for performing the above-described methods. For example, the non-transitory computer-readable storage medium may be a ROM, a RAM, a CD-ROM, a magnetic tape, a floppy disc, an optical data storage device, and the like.

FIG. 3 is a block diagram of a server 104 for switching live-streaming rooms according to some embodiments of the present disclosure. Referring to FIG. 3, the server 104 may include a processing component 302, which may further include one or more processors, and memory resources represented by a memory 304, for storing instructions executable by the processing component 302, such as application programs. The application programs stored in the memory 304 may include one or more modules each corresponding to a set of instructions. In addition, the processing component 302 may be configured to execute instructions to perform the above-mentioned methods for switching live-streaming rooms.

The server 104 may also include a power component 306 configured to perform power management of the server 104, a wired or wireless network interface 308 configured to connect the server 104 to a network, and an input/output (I/O) interface 310. The server 104 may operate based on an operating system stored in the memory 304, such as Windows Server™, Mac OS X™, Unix™, Linux™, FreeBSD™ or the like.

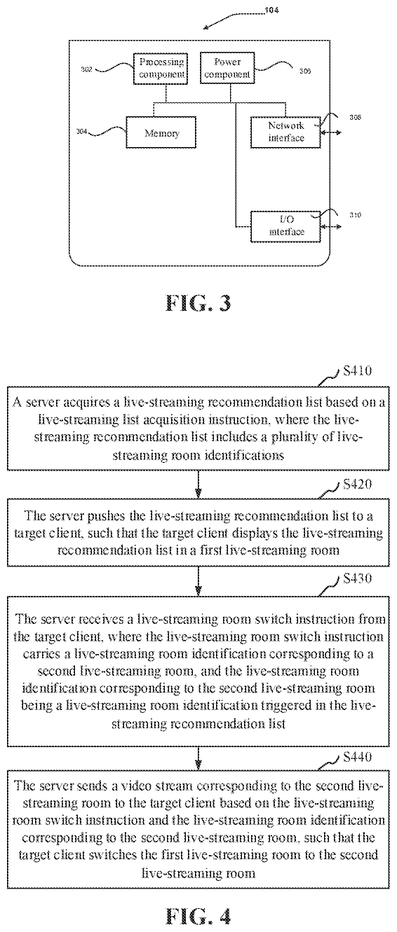

FIG. 4 is a schematic flowchart of a method for switching live-streaming rooms according to some embodiments of the present disclosure. The method is executable by the server 104 in FIG. 1. As shown in FIG. 4, the method for switching live-streaming rooms includes the following steps:

In step S410, a server acquires a live-streaming recommendation list based on a live-streaming list acquisition instruction, where the live-streaming recommendation list includes a plurality of live-streaming room identifications.

The live-streaming room identifications are used to uniquely distinguish between live-streaming rooms. In some embodiments, the live-streaming list acquisition instruction is triggered by an audience through a target client, for example, triggered by tapping a portal, a “Live-streaming notification” button, or the like on the target client. The target client acquires the live-streaming list acquisition instruction and sends the live-streaming list acquisition instruction to the server. The live-streaming list acquisition instruction carries information of an account logged in the target client. The information of the account is a user identification corresponding to the audience. The user identification is the ID, mobile phone number, or the like of the audience. This is not limited herein. It should be noted that in the present disclosure, the target client needs to acquire the user's consent when acquiring the information of the account. In other words, the information of the account involved in the present disclosure is acquired after being authorized by users or fully authorized by various parties.

The server acquires the live-streaming recommendation list based on the information of the account in the live-streaming list acquisition instruction. The live-streaming recommendation list is generated by the server in an offline state, or generated by the server after acquiring the live-streaming list acquisition instruction. This is not limited herein. The live-streaming recommendation list includes the live-streaming room identifications corresponding to a plurality of live-streaming moms and live-streaming room information corresponding to each of the live-streaming room identifications. The live-streaming room information includes at least one of anchor information, live-streaming content, and the like. For example, live-streaming information includes at least one of the profile photo, nickname, and profile information of an anchor; and the live-streaming content includes at least one of sold item information and a live-streaming image. The plurality of live-streaming rooms are determined by the server from a live-streaming mom library through calculation based on information related to the account. The relevant information includes, but is not limited to, at least one of followed information and history behavior data corresponding to the information of the account. The history behavior data includes feedback information on live-streaming rooms and the like.

In some embodiments, the target client does not transmit the live-streaming list acquisition instruction to the server; and the server actively acquires the live-streaming recommendation list. In this case, in S410, the server acquires the live-streaming recommendation list. The server periodically acquires the live-streaming recommendation list; or acquires the live-streaming recommendation list in response to start of live-streaming of live-streaming rooms followed by the account. In some embodiments, the acquiring, by the server, the live-streaming recommendation list includes: in a process of playing a video stream corresponding to the first live-streaming room on the target client, acquiring the live-streaming recommendation list including an identification of another live-streaming room followed by an account logged in the target client in response to start of live-streaming of the another live-streaming room.

In step S420, the server sends the live-streaming recommendation list to the target client, such that the target client displays the live-streaming recommendation list in the first live-streaming room.

The first live-streaming room is a live-streaming room viewed in a current viewing interface on the target client. The target client displays the live-streaming recommendation list in the first live-streaming room through a preset display method. The preset display method includes at least one of a display in a preset position in the first live-streaming room, a display in a hidden sidebar, a pop-up in the live-streaming interface, and the like. For example, in the case that the preset display method includes a display in the preset position in the first live-streaming room, the target client displays the live-streaming recommendation list in the preset position in the first live-streaming room. The live-streaming recommendation list includes the live-streaming room identifications corresponding to the plurality of live-streaming rooms and the live-streaming room information corresponding to each of the live-streaming room identifications. Correspondingly, the target client displays the live-streaming room identifications corresponding to the plurality of live-streaming rooms and the live-streaming room information corresponding to each of the live-streaming room identifications in the preset position in the current viewing interface. The preset position is a sidebar position in the first live-streaming room or a notification bar position in the first live-streaming room.

The target client displays the plurality of live-streaming room identifications and the live-streaming room information corresponding to each of the live-streaming room identifications in the preset position in the first live-streaming room, and the audience can trigger a live-streaming room identification corresponding to a second live-streaming room to be switched based on the live-streaming room information corresponding to each of the live-streaming room identifications, to select the live-streaming room identification corresponding to the second live-streaming room. The target client acquires the live-streaming room identification corresponding to the second live-streaming room and sends a live-streaming room switch instruction to the server, where the live-streaming room switch instruction carries the live-streaming room identification corresponding to the second live-streaming room. Then, S430 is performed.

In step S430, the server receives the live-streaming room switch instruction from the target client, wherein the live-streaming room switch instruction carries the live-streaming room identification corresponding to the second live-streaming room, and the live-streaming room identification corresponding to the second live-streaming room is a live-streaming room identification triggered in the live-streaming recommendation list.

In step S440, the server sends a video stream corresponding to the second live-streaming room to the target client based on the live-streaming room switch instruction and the live-streaming room identification corresponding to the second live-streaming room, such that the target client switches the first live-streaming room to the second live-streaming room based on the video stream corresponding to the second live-streaming room.

In some embodiments, after acquiring the live-streaming recommendation list through the target client, the audience triggers the live-streaming room switch instruction to the target client by tapping the live-streaming room identification corresponding to the second live-streaming room to which the audience wants to switch or through another method. The target client sends the live-streaming room switch instruction to the server. The server receives the live-streaming mom switch instruction, determines the video stream corresponding to the second live-streaming room based on the live-streaming room identification corresponding to the second live-streaming room carried in the live-streaming room switch instruction, and sends the video stream corresponding the second live-streaming room to the target client. The target client receives the video stream corresponding to the second live-streaming room sent by the server, and switches the first live-streaming room to the second live-streaming room based on the video stream corresponding to the second live-streaming room.

In the foregoing method for switching live-streaming rooms, the live-streaming recommendation list is acquired based on the live-streaming list acquisition instruction; and the live-streaming recommendation list is pushed to the target client, such that the target client displays the plurality of live-streaming room identifications and the live-streaming mom information corresponding to each of the live-streaming room identifications in the live-streaming recommendation list in the preset position in the first live-streaming room, and the audience can acquire recommended live-streaming information when viewing the first live-streaming room. The live-streaming room switch instruction is received from the target client, where the live-streaming room switch instruction carries the live-streaming room identification corresponding to the second live-streaming room, and the live-streaming room identification corresponding to the second live-streaming room is the live-streaming room identification triggered in the plurality of live-streaming room identifications; and the video stream corresponding to the second live-streaming room is sent to the target client based on the live-streaming room switch instruction and the live-streaming room identification corresponding to the second live-streaming room, such that the target client switches the first live-streaming mom to the second live-streaming room based on the video stream corresponding to the second live-streaming room. When the audience needs to switch live-streaming rooms, the audience can directly select the live-streaming room to which the audience wants to switch in the current viewing interface. In this way, there is no need to exit from the current live-streaming room to a live-streaming square, and the operation is simple. In addition, because the audience can conveniently acquire recommended live-streaming rooms, a success rate of live-streaming recommendation and viewing duration of the audience can be improved.

In some embodiments, before the server acquires the live-streaming recommendation list based on the live-streaming list acquisition instruction, the method further includes: acquiring, by the server, at least one of followed information and history behavior data of an account logged in the target client, and determining, by the server, the live-streaming recommendation list based on at least one of the followed information and history behavior data.

FIG. 5 is a schematic flowchart of generating a live-streaming recommendation list according to some embodiments of the present disclosure. As shown in FIG. 5, the determining the live-streaming recommendation list based on at least one of the followed information and history behavior data includes the following steps.

In step S510, the server determines a first to-be-recommended live-streaming room identification based on the followed information, where the first to-be-recommended live-streaming room identification is a live-streaming room identification of an on-air live-streaming room that has been followed by the account.

The account includes the user identification, and the followed information includes at least one of a live-streaming room identification and an anchor identification followed by the user identification. The target client establishes a following relationship between the user identification and the followed information in real-time in response to acquiring, by the target client, live-streaming room following instruction triggered by the audience. In some embodiments, in response to the audience logs in the target client or opens the target client based on the user identification, the server acquires the user identification corresponding to the audience based on logged-in information sent by the target client, queries a followed live-streaming room from the established following relationship between the user identification and the followed information based on the user identification, and determines the identification of the followed on-air live-streaming room as the first to-be-recommended live-streaming room identification.

In step S520, the server determines a second to-be-recommended live-streaming room identification based on the history behavior data.

The history behavior data includes at least one history access behavior of the audience, and live-streaming room information, access duration, and the like corresponding to each history access behavior. History access behaviors include, but are not limited to, viewing, like, gift-giving, and following. The server queries corresponding history behavior data based on the user identification. In some embodiments, the determining, by the server, the second to-be-recommended live-streaming room identification based on the history behavior data includes steps (1) and (2).

(1) The server determines an identification corresponding to a live-streaming room in which the audience is interested based on the history behavior data.

The server may select live-streaming rooms that the audience has viewed recently and live-streaming rooms to which the audience has given gifts recently as live-streaming rooms in which the audience is interested based on the history behavior data. The number of the live-streaming rooms that the audience has viewed recently, as selected, may be a first preset quantity, and the number of the live-streaming rooms to which the audience has given gifts recently, as selected, may be a second preset quantity. The first preset quantity and the second preset quantity can both be set and changed as required. This is not particularly limited in this embodiment. For example, the first preset quantity is 80 and the second preset quantity is 20.

(2) The server determines the second to-be-recommended live-streaming room identification based on the identification corresponding to the live-streaming room interested by the audience.

In some embodiments, the server determines the identification of the live-streaming room interested by the audience as the second to-be-recommended live-streaming room identification. In some embodiments, the server determines the live-streaming room in which the audience is interested as a seed live-streaming room, and selects identifications corresponding to live-streaming rooms with highest similarity to the seed live-streaming rooms from the live-streaming room library as the second to-be-recommended live-streaming room identification based on a depth learning algorithm. And the number of the identifications corresponding to live-streaming rooms, as above selected, may be a third preset quantity. In some embodiments, the server determines the identification of the on-air live-streaming room interested by the audience as the second to-be-recommended live-streaming room identification.

In some embodiments, the server determines the identification of the live-streaming room interested by the audience as a reference, and determines an identification of another live-streaming room in a pre-constructed multi-dimensional live-streaming index and at a short distance from the live-streaming mom interested by the audience as the second to-be-recommended live-streaming room identification. The server matches information about a live-streaming room in different dimensions in the multi-dimensional live-streaming index with the identification of the live-streaming room interested by the audience to acquire a distance between the identification of the live-streaming room in the multi-dimensional live-streaming index and the identification of the live-streaming room interested by the audience. It can be understood that live-streaming room identifications in the multi-dimensional live-streaming index do not include this live-streaming room interested by the audience. The server sorts the live-streaming room identifications in ascending order and acquires identifications corresponding to live-streaming rooms at the shortest distances from (that is, with the highest similarity to) the live-streaming room in which the audience is interested as the second to-be-recommended live-streaming room identification. And the number of the identifications corresponding to live-streaming rooms, as above acquired, may be a fourth preset quantity. The fourth preset quantity includes, but is not limited to, 100.

In some embodiments, the server further acquires an on-air status corresponding to the second to-be-recommended live-streaming room identification, and arranges a second to-be-recommended on-air live-streaming room identification at the top of the live-streaming recommendation list.

In this embodiment of the present disclosure, the multi-dimensional live-streaming index is searched for the identifications of the live-streaming rooms with high similarity to the live-streaming room interested by the audience to recommend identifications of all the live-streaming rooms that the audience may like to the user, such that the audience can acquire enough information about the recommended live-streaming rooms.

In S530, the server generates the live-streaming recommendation list based on at least one of the first to-be-recommended live-streaming room identification and the second to-be-recommended live-streaming room identification.

In this embodiment of the present disclosure, the server generates the live-streaming recommendation list based on the first to-be-recommended live-streaming room identification; or generates the live-streaming recommendation list based on the second to-be-recommended live-streaming room identification; or generates the live-streaming recommendation list based on the first to-be-recommended live-streaming room identification and the second to-be-recommended live-streaming room identification. That the server generates the live-streaming recommendation list based on the first to-be-recommended live-streaming room identification and the second to-be-recommended live-streaming room identification includes: generating, by the server, a first live-streaming recommendation list based on the first to-be-recommended live-streaming room identification and a second live-streaming recommendation list based on the second to-be-recommended live-streaming room identification, and assembles the first live-streaming recommendation list and the second live-streaming recommendation list as the live-streaming recommendation list.

In some embodiments, after generating the live-streaming recommendation list, the server directly sends the live-streaming recommendation list to the target client; or the server sends the live-streaming recommendation list to the target client in response to receiving the live-streaming list acquisition instruction from the target client.

In this embodiment of the present disclosure, the live-streaming recommendation list pushed to the target client is determined based on the followed information and history behavior data, such that the accuracy of the live-streaming room recommendation can be improved, and the success rate of the live-streaming room recommendation, the viewing duration of the audience, and the income of anchors can be improved.

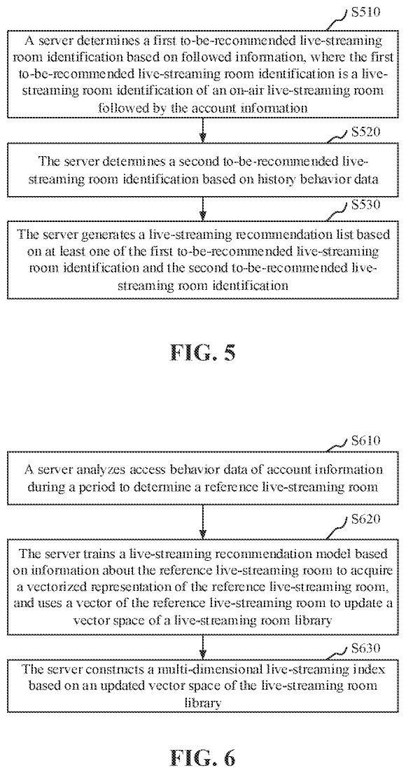

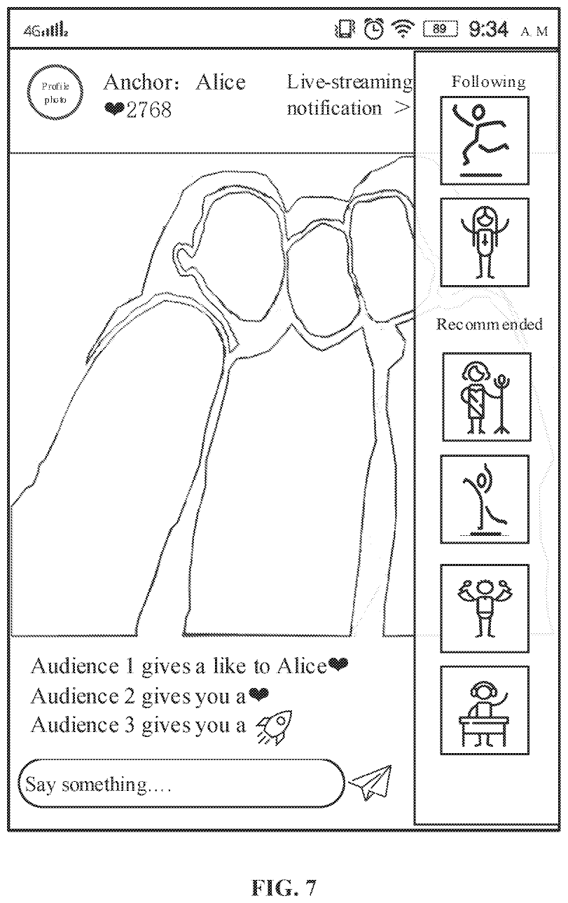

FIG. 6 is a schematic flowchart of generating a multi-dimensional live-streaming index according to some embodiments of the present disclosure. As shown in FIG. 6, the method for generating a multi-dimensional live-streaming index includes the following steps:

In step S610, a server analyzes access behavior data of an account during a period to determine reference live-streaming rooms.

In response to generating the access behavior of the audience by a live-streaming platform, the server acquires the access behavior corresponding to the account and generates the access behavior data based on the access behavior. The server periodically analyzes the access behavior data in the period, and filters access behaviors and corresponding accessed live-streaming rooms included in the access behavior data in the period to determine the reference live-streaming rooms. The server presets an analysis timing and period. For example, the period is set to one day, and the server performs analysis at 24:00 every day. In some embodiments, the access behavior refers to viewing live-streaming. The server filters live-streaming rooms viewed by the audience during the period based on the duration of viewing the live-streaming rooms to filter out live-streaming rooms with short viewing duration (for example, less than 2 minutes) and determine the remaining live-streaming rooms as the reference live-streaming rooms.

In step S620, the server trains a live-streaming recommendation model based on the information about the reference live-streaming rooms to acquire vectorized representations of the reference live-streaming rooms, and uses the vectors of the reference live-streaming rooms to update the vector space of a live-streaming room library.

Before live-streaming, an anchor needs to register an account on the live-streaming platform. During the registration, the anchor needs to input relevant information of a live-streaming room, such as the name and ID card number of the anchor and the category of the live-streaming room. The server stores the relevant information of the live-streaming room, and after determining the reference live-streaming rooms, the server composes the information about the reference live-streaming room by calling the registration information to be used. Because live-streaming rooms viewed by a same user has specific similarity, the server trains the live-streaming recommendation model by the information about the reference live-streaming moms to acquire the vectorized representations of the information about the reference live-streaming rooms. The live-streaming recommendation model is word2vec (a group of related models used to generate word vectors). Then, the acquired vectorized representations of the reference live-streaming rooms are used to update the embedding vector space of live-streaming rooms, such that the vectors of other live-streaming rooms in the live-streaming room library closer to the vectors of the reference live-streaming rooms are at shorter distances in the embedding vector space.

In step S630, the server constructs a multi-dimensional live-streaming index based on the updated vector space of the live-streaming room library.

The server constructs the multi-dimensional live-streaming index by a similarity search algorithm based on the updated vector space of the live-streaming room library. The similarity search algorithm adopts the approximate nearest neighbors oh yeah (ANNOY) algorithm. The goal of the ANNOY algorithm is to establish a data structure to search for the nearest point of any search point in a short time. In this embodiment, the vector space of the live-streaming room library is updated in advance, such that the live-streaming rooms more similar to the reference live-streaming rooms are at shorter distances in the vector space, the time taken to search for the recommended live-streaming rooms can be reduced to improve live-streaming room recommendation efficiency. The process of generating the multi-dimensional live-streaming index described in steps 610 to 630 is completed by the server in an offline state.

In some embodiments, the method for switching live-streaming rooms further includes: generating, by the server, a live-streaming list acquisition instruction in response to start of live-streaming of a live-streaming room followed by the account.

An anchor client transmits a live-streaming notification to the server in response to start of the live-streaming, where the live-streaming notification carries live-streaming room information, such as an anchor ID, a live-streaming room identification, and the like. The server acquires and records the information about the live-streaming room. Based on the information about the live-streaming room that recently starts live-streaming, the server periodically searches for a user identification following the live-streaming room from a stored following relationship between the user identification and followed information, and actively pushes live-streaming information to a target client corresponding to the user identification. The target client displays the live-streaming start information in the current live-streaming interface.

In this embodiment, the server enables the user to timely acquire the on-air status of the followed live-streaming room by actively pushing the live-streaming start information to the audience in response to start of live-streaming of the live-streaming room followed by the audience. This can avoid the user from missing favorite live-streaming and further increase the duration of viewing the live-streaming by the user because the followed live-streaming room is often the user's favorite type.

FIG. 7 is a schematic diagram of displaying a live-streaming recommendation list in a sidebar of a first live-streaming room on a target client. The target client hides the sidebar while an audience is viewing live-streaming. In response to a need to acquire recommended live-streaming rooms, the audience displays the live-streaming recommendation list in the sidebar by tapping the sidebar or a “Start notification” button. In this embodiment of the present disclosure, the live-streaming recommendation list is displayed in the sidebar, such that the audience can timely acquire the information about followed live-streaming rooms and live-streaming rooms in which the audience may be interested without affecting live-streaming viewing.

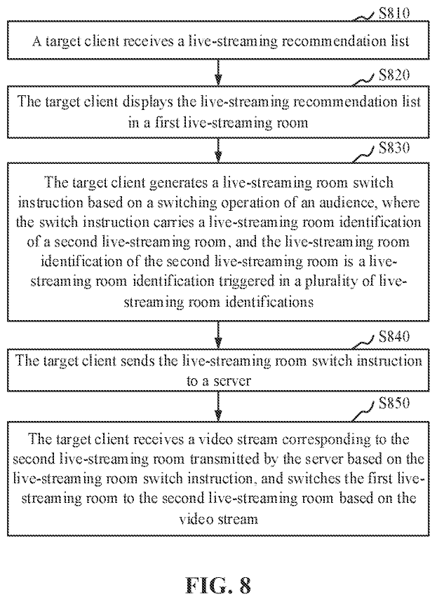

FIG. 8 is a schematic flowchart of a method for switching live-streaming rooms according to some embodiments of the present disclosure. The method is executable by the target client 102 in FIG. 1 and includes the following steps:

In step S810, the target client receives a live-streaming recommendation list.

A live-streaming list acquisition instruction can be triggered through the target client in response to a need of an audience to acquire the information about recommended live-streaming rooms. For example, a portal, a “Start notification” button, or the like is tapped through the target client to trigger the live-streaming list acquisition instruction. The target client acquires the live-streaming list acquisition instruction and transmits the live-streaming list acquisition instruction to a server. The live-streaming list acquisition instruction carries information of an account logged in the target client. The information of the account may be a user identification. For example, the user identification is the ID, mobile phone number, or the like of the user. This is not limited herein.

The server acquires the live-streaming recommendation list based on the information of the account in the live-streaming list acquisition instruction and transmits the live-streaming recommendation list to the target client. The live-streaming recommendation list is generated by the server in an offline state, or generated by the server after the server acquires the live-streaming list acquisition instruction. This is not limited herein. The live-streaming recommendation list includes a plurality of live-streaming room identifications and live-streaming room information corresponding to each live-streaming room identification. The live-streaming room information includes at least one of anchor information, live-streaming content, and the like. The plurality of live-streaming room identifications are determined by the server from a live-streaming room library based on at least one of followed information and history behavior data of the account.

In step S820, the target client displays the live-streaming recommendation list in a first live-streaming room.

The live-streaming recommendation list includes the plurality of live-streaming room identifications and the live-streaming room information corresponding to each of the live-streaming room identifications. In some embodiments, the target client displays the plurality of live-streaming room identifications and the live-streaming room information corresponding to each of the live-streaming room identifications in a preset position in the first live-streaming room.

In an embodiment, the preset position includes a sidebar position in the first live-streaming room or a notification bar position in the first live-streaming room.

FIG. 7 is a schematic diagram of displaying a live-streaming recommendation list in a sidebar of a first live-streaming room on a target client. The target client hides the sidebar while an audience is viewing live-streaming. In response to a need to acquire recommended live-streaming rooms, the audience displays the live-streaming recommendation list in the sidebar by tapping the sidebar or a “Start notification” button. In this embodiment, the live-streaming recommendation list is displayed in the sidebar, such that the audience can timely acquire the information about followed live-streaming rooms and live-streaming rooms in which the audience may be interested without affecting live-streaming viewing.

In step S830, the target client generates a live-streaming room switch instruction based on a switching operation of the audience, where the switch instruction carries a live-streaming room identification of a second live-streaming room, and the live-streaming room identification of the second live-streaming room is a live-streaming room identification triggered in the plurality of live-streaming room identifications.

In step S840, the target client sends the live-streaming room switch instruction to the server.

In step S850, the target client receives a video stream corresponding to the second live-streaming room transmitted by the server based on the live-streaming room switch instruction, and switches the first live-streaming room to the second live-streaming room based on the video stream.

After acquiring the live-streaming recommendation list through the target client, the audience triggers the live-streaming room switch instruction to the target client by tapping the information about the live-streaming room to which the audience wants to switch or through another method. The target client transmits the live-streaming room switch instruction to the server. The server receives the live-streaming room switch instruction, determines the video stream corresponding to the second live-streaming room based on the live-streaming room identification of the second live-streaming room carried in the live-streaming room switch instruction, and sends the video stream corresponding to the second live-streaming room to the target client. The target client receives the video stream corresponding to the second live-streaming room sent by the server, and switches the first live-streaming room to the second live-streaming room based on the video stream.

In this embodiment, the live-streaming recommendation list is displayed in the first live-streaming room, such that the audience can directly acquire the recommended live-streaming room information while viewing the first live-streaming room. When the audience needs to switch live-streaming rooms, the audience needs only to trigger a live-streaming list acquisition instruction in the current viewing interface. The operation is simple.

In some embodiments, the live-streaming recommendation list is generated by the server based on at least one of the followed information and history behavior data of the account.

In this embodiment of the present disclosure, the live-streaming recommendation list is determined based on at least one of the followed information and history behavior data, such that the accuracy of recommended live-streaming rooms can be improved, and the success rate of the live-streaming room recommendation, the viewing duration of the audience, and the income of anchors can be improved.

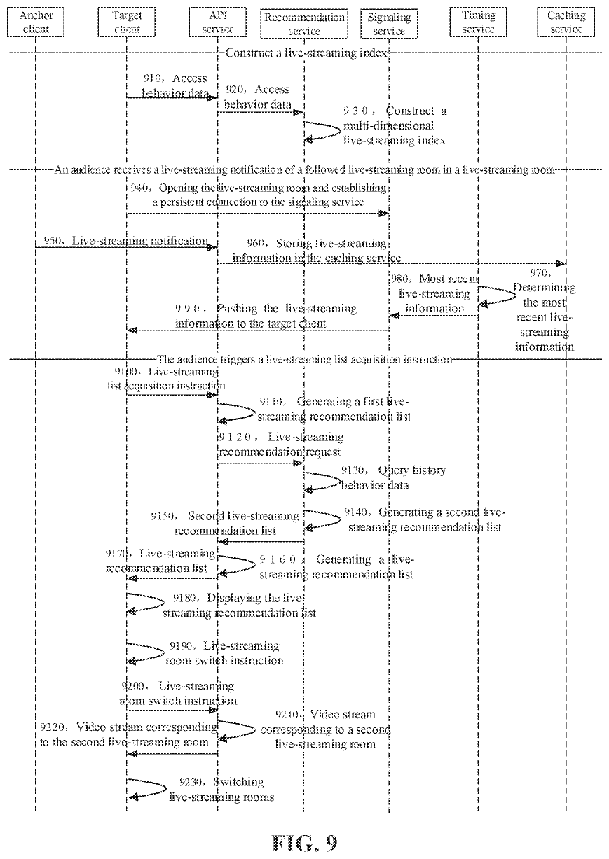

FIG. 9 is a schematic flowchart of a method for switching live-streaming rooms according to some embodiments of the present disclosure. The method is executable by a server. Services including but not limited to an application programming interface (API) service, a recommendation service, a signaling service, a timing service, and a caching service are implemented by the server. The API service is configured to acquire access data behaviors of audiences and notifications on live-streaming of live-streaming rooms, and receive or transmit various instructions triggered by the audiences through target clients in real-time; the recommendation service is configured to generate a multi-dimensional live-streaming index and use the multi-dimensional live-streaming index to query recommended live-streaming moms; the signaling service is configured to transmit live-streaming information of followed live-streaming rooms to the target clients; the timing service is configured to calculate live-streaming information of live-streaming rooms; and the caching service is configured to store live-streaming records of the live-streaming rooms. The method includes the following steps.

In step 910, the target client transmits access behavior data to the API service.

In step 920, the API service transmits the access behavior data to the recommendation service.

In step 930, the recommendation service generates a multi-dimensional live-streaming index based on the access behavior data.

The recommendation service periodically determines a reference live-streaming room based on access behavior data during a period. A live-streaming recommendation model is trained by the information about the reference live-streaming room to acquire a vectorized representation of the reference live-streaming room. Then, a distance between the vector of another live-streaming room in the live-streaming room library and the vector of the reference live-streaming room is determined, and the vector space of the live-streaming room library is updated based on the distance. Next, the ANNOY algorithm is used to construct the multi-dimensional live-streaming index based on the updated vector space of the live-streaming room library.

In step 940, the target client opens a live-streaming room and establishes a persistent connection to the signaling service.

In step 950, the live-streaming room of an anchor starts live-streaming. The API service acquires a live-streaming notification and generates live-streaming information.

In step 960, the API service stores the live-streaming information in the caching service.

In step 970, the timing service determines the most recent live-streaming information.

In step 980, the timing service transmits the most recent live-streaming information to the signaling service.

In step 990, the signaling service pushes the live-streaming information to the target client following the most recent on-air live-streaming room.

In step 9100, the audience triggers a live-streaming list acquisition instruction. The live-streaming list acquisition instruction carries a user identification.

In step 9110, the API service acquires the corresponding followed live-streaming room based on the user identification, uses the identification of an on-air live-streaming room in followed live-streaming rooms as a first to-be-recommended live-streaming room identification, and generates a first live-streaming recommendation list.

In step 9120, the API service issues a live-streaming recommendation request to the recommendation service. The live-streaming recommendation request carries information of an account.

In step 9130, the recommendation service queries corresponding history behavior data based on the user identification to determine a live-streaming room interested by the audience.

In step 9140, the recommendation service searches for the identification of a live-streaming room with high similarity in the multi-dimensional live-streaming index to the live-streaming room interested by the audience as a second to-be-recommended live-streaming room, and generates a second live-streaming recommendation list.

In step 9150, the recommendation service transmits the second live-streaming recommendation list to the API service.

In step 9160, the API service assembles the first live-streaming recommendation list and the second live-streaming recommendation list to generate a live-streaming recommendation list.

In step 9170, the API service transmits the live-streaming recommendation list to the target client.

In step 9180, the target client displays the live-streaming recommendation list in a first live-streaming room.

In step 9190, the audience triggers a live-streaming room switch instruction, where the live-streaming room switch instruction carries a live-streaming room identification of a second live-streaming room.

The live-streaming room identification of the second live-streaming room is a live-streaming room identification triggered in the live-streaming recommendation list.

In step 9200, the target client transmits the live-streaming room switch instruction to the API service.

In step 9210, the API service acquires a video stream corresponding to the second live-streaming room.

In step 9220, the API service transmits the video stream corresponding to the second live-streaming room to the target client.

In step 9230, the target client switches the first live-streaming mom to the second live-streaming room based on the video stream corresponding to the second live-streaming room.

It should be understood that although the steps in the flowcharts of FIG. 4 to FIG. 6, FIG. 8, and FIG. 9 are shown in sequence as indicated by arrows, these steps are not necessarily performed in sequence as indicated by arrows. Unless explicitly stated herein, the execution of these steps is not strictly limited in sequence, and these steps may be executed in other sequences. In addition, at least some steps in FIG. 1 to FIG. 6 may include a plurality of substeps or a plurality of stages, which are not necessarily executed at the same time, but may be executed at different time points. The execution order of these substeps or stages is not necessarily sequential, and these substeps or stages may be executed alternately with other steps or at least some substeps or stages of other steps.

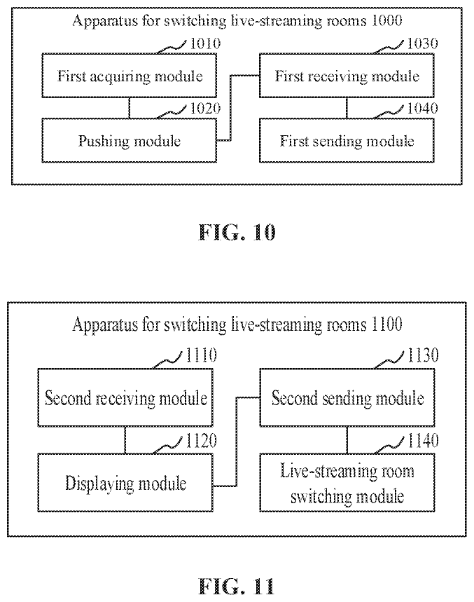

FIG. 10 is a block diagram of an apparatus 1000 for switching live-streaming rooms according to some embodiments of the present disclosure. Referring to FIG. 10, the apparatus includes a first acquiring module 1010, a pushing module 1020, a first receiving module 1030, and a first sending module 1040.

The first acquiring module 1010 is configured to acquire a live-streaming recommendation list, where the live-streaming recommendation list includes a plurality of live-streaming room identifications.

The pushing module 1020 is configured to push the live-streaming recommendation list to a target client, where the target client is configured to display the live-streaming recommendation list in a first live-streaming room;

The first receiving module 1030 is configured to receive a live-streaming room switch instruction from the target client, where the live-streaming room switch instruction carries a live-streaming room identification corresponding to a second live-streaming room, and the live-streaming room identification of the second live-streaming room is a live-streaming room identification triggered in the live-streaming recommendation list.

The first sending module 1040 is configured to send a video stream corresponding to the second live-streaming room to the target client based on the live-streaming room switch instruction and the live-streaming room identification corresponding to the second live-streaming room.

In some embodiments, the first acquiring module 1010 is configured to acquire at least one of followed information and history behavior data of an account logged in the target client; and determine the live-streaming recommendation list based on at least one of the followed information and history behavior data.

In some embodiments, the first acquiring module 1010 includes a first to-be-recommended live-streaming room determining submodule, a second to-be-recommended live-streaming room determining submodule, and a live-streaming recommendation list generation submodule.

The first to-be-recommended live-streaming room determining submodule is configured to determine a first to-be-recommended live-streaming room identification based on the followed information, where the first to-be-recommended live-streaming room identification is a live-streaming room identification of an on-air live-streaming room followed by the account.

The second to-be-recommended live-streaming mom determining submodule is configured to determine a second to-be-recommended live-streaming room identification based on the history behavior data.

The live-streaming recommendation list generation submodule is configured to generate the live-streaming recommendation list based on at least one of the first to-be-recommended live-streaming mom identification and the second to-be-recommended live-streaming room identification.

In some embodiments, the first acquiring module 1010 is configured to receive a live-streaming list acquisition instruction from the target client, and acquire the live-streaming recommendation list based on the live-streaming list acquisition instruction.

Alternatively, the first acquiring module 1010 is configured to: in a process of playing a video stream corresponding to the first live-streaming room on the target client, acquire the live-streaming recommendation list including an identification of another live-streaming room followed by an account logged in the target client in response to start of live-streaming of the another followed live-streaming room.

In some embodiments, the target client is configured to display the live-streaming recommendation list in a preset position in the first live-streaming room, where the preset position includes:

a sidebar position in the first live-streaming room or a notification bar position in the first live-streaming room.

In some embodiments, the first acquiring module 1010 is configured to acquire the plurality of live-streaming room identifications and live-streaming room information corresponding to each of the live-streaming room identifications; and generate the live-streaming recommendation list based on the plurality of live-streaming room identifications and the live-streaming room information corresponding to each of the live-streaming room identifications, where the live-streaming recommendation list further includes the live-streaming room information corresponding to each of the live-streaming room identifications.

FIG. 11 is a block diagram of an apparatus 1100 for switching live-streaming rooms according to some embodiments of the present disclosure. Referring to FIG. 11, the apparatus includes a second receiving module 1110, a displaying module 1120, a second sending module 1130, and a live-streaming room switching module 1140.

The second receiving module 1110 is configured to receive a live-streaming recommendation list, wherein the live-streaming recommendation list includes a plurality of live-streaming room identifications.

The displaying module 1120 is configured to display the live-streaming recommendation list in a first live-streaming room.

The second sending module 1130 is configured to send a live-streaming room switch instruction to a server, where the live-streaming room switch instruction carries a live-streaming room identification corresponding to a second live-streaming room, and the live-streaming room identification corresponding to the second live-streaming room is a live-streaming room identification triggered in the live-streaming recommendation list.

The live-streaming room switching module 1140 is configured to receive a video stream corresponding to the second live-streaming room from the server, and switch the first live-streaming room to the second live-streaming room based on the video stream.

In some embodiments, the displaying module 1120 is configured to display the live-streaming recommendation list in a preset position in the first live-streaming room, where the preset position includes a sidebar position in the first live-streaming room or a notification bar position in the first live-streaming room.

In some embodiments, the apparatus 1100 for switching live-streaming rooms further includes:

the displaying module 1120 further configured to display a list acquisition button in the first live-streaming room; and

a third sending module configured to send a live-streaming list acquisition instruction to the server in response to the list acquiring button being triggered, where the live-streaming list acquisition instruction carries information of an account logged in the client.

In some embodiments, the live-streaming recommendation list is generated based on at least one of followed information and history behavior data of the account logged in the client.

In an embodiment, the live-streaming recommendation list further includes live-streaming room information corresponding to each of the live-streaming room identifications.

With regard to the apparatus in the above embodiment, the specific fashion in which the respective modules perform the operations has been described in detail in embodiment of the related methods, and will not be explained in detail herein.

Other embodiments of the present disclosure will be apparent to those skilled in the art from consideration of the description and practice of the present disclosure disclosed here. The present disclosure is intended to cover any variations, uses, or adaptations of the present disclosure and include the common sense or conventional technical means in the art not disclosed in the present disclosure and following the general principles thereof. It is intended that the description and embodiments should be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for switching live-streaming rooms, applicable to a server, the method comprising:
acquiring a live-streaming recommendation list, wherein the live-streaming recommendation list comprises a plurality of live-streaming room identifications;
pushing the live-streaming recommendation list to a target client, wherein the target client is configured to display the live-streaming recommendation list in a first live-streaming room;
receiving a live-streaming room switch instruction from the target client, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and
sending a video stream corresponding to the second live-streaming room to the target client based on the live-streaming room switch instruction and the live-streaming room identification corresponding to the second live-streaming room.

2. The method according to claim 1, wherein said acquiring the live-streaming recommendation list comprises:
acquiring at least one of followed information and history behavior data of an account logged in the target client; and
determining the live-streaming recommendation list based on at least one of the followed information and the history behavior data.

3. The method according to claim 2, wherein said determining the live-streaming recommendation list based on at least one of the followed information and the history behavior data comprises:
determining a first to-be-recommended live-streaming room identification based on the followed information, wherein the first to-be-recommended live-streaming room identification is a live-streaming room identification of an on-air live-streaming room followed by the account;
determining a second to-be-recommended live-streaming room identification based on the history behavior data; and
generating the live-streaming recommendation list based on at least one of the first to-be-recommended live-streaming room identification and the second to-be-recommended live-streaming room identification.

4. The method according to claim 1, wherein said acquiring the live-streaming recommendation list comprises:
receiving a live-streaming list acquisition instruction from the target client, and acquiring the live-streaming recommendation list based on the live-streaming list acquisition instruction.

5. The method according to claim 1, wherein said acquiring the live-streaming recommendation list comprises:
in a process of playing a video stream corresponding to the first live-streaming room on the target client, acquiring the live-streaming recommendation list comprising an identification of another live-streaming room followed by an account logged in the target client in response to start of live-streaming of the another live-streaming room.

6. The method according to claim 1, wherein the target client is configured to display the live-streaming recommendation list in a preset position in the first live-streaming room;
wherein the preset position comprises a sidebar position in the first live-streaming room or a notification bar position in the first live-streaming room.

7. The method according to claim 1, wherein said acquiring the live-streaming recommendation list comprises:
acquiring the plurality of live-streaming room identifications and live-streaming room information corresponding to each of the live-streaming room identifications; and
generating the live-streaming recommendation list based on the plurality of live-streaming room identifications and the live-streaming room information corresponding to each of the live-streaming room identifications, wherein the live-streaming recommendation list further comprises the live-streaming room information corresponding to each of the live-streaming room identifications.

8. A method for switching live-streaming rooms, applicable to a client, the method comprising:
receiving a live-streaming recommendation list, wherein the live-streaming recommendation list comprises a plurality of live-streaming room identifications;
displaying the live-streaming recommendation list in a first live-streaming room;
sending a live-streaming room switch instruction to a server, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and
receiving a video stream corresponding to the second live-streaming room from the server, and switching the first live-streaming room to the second live-streaming room based on the video stream.

9. The method according to claim 8, wherein said displaying the live-streaming recommendation list in the first live-streaming room comprises:
displaying the live-streaming recommendation list in a preset position in the first live-streaming room, wherein the preset position comprises a sidebar position in the first live-streaming room or a notification bar position in the first live-streaming room.

10. The method according to claim 8, further comprising:
displaying a list acquisition button in the first live-streaming room; and
sending a live-streaming list acquisition instruction to the server in response to the list acquisition button being triggered, wherein the live-streaming list acquisition instruction carries information of an account logged in the client.

11. The method according to claim 8, wherein the live-streaming recommendation list is generated based on at least one of followed information and history behavior data of an account logged in the client.

12. The method according to claim 8, wherein the live-streaming recommendation list further comprises live-streaming room information corresponding to each of the live-streaming room identifications.

13. A server, comprising:
one or more processors, and
a memory configured to store one or more instructions executable by the one or more processors,
wherein the one or more processors, when executing the one or more instructions, are caused to perform:
acquiring a live-streaming recommendation list, wherein the live-streaming recommendation list comprises a plurality of live-streaming room identifications;
pushing the live-streaming recommendation list to a target client, wherein the target client is configured to display the live-streaming recommendation list in a first live-streaming room;
receiving a live-streaming room switch instruction from the target client, wherein the live-streaming room switch instruction carries a live-streaming room identification corresponding to a second live-streaming room, and the live-streaming room identification corresponding to the second live-streaming room is a live-streaming room identification triggered in the live-streaming recommendation list; and
sending a video stream corresponding to the second live-streaming room to the target client based on the live-streaming room switch instruction and the live-streaming room identification corresponding to the second live-streaming room.

14. The server according to claim 13, wherein the one or more processors, when executing the one or more instructions, are caused to perform:
acquiring at least one of followed information and history behavior data of an account logged in the target client; and
determining the live-streaming recommendation list based on at least one of the followed information and the history behavior data.

15. The server according to claim 14, wherein the one or more processors, when executing the one or more instructions, are caused to perform:
determining a first to-be-recommended live-streaming room identification based on the followed information, wherein the first to-be-recommended live-streaming room identification is a live-streaming room identification of an on-air live-streaming room followed by the account;
determining a second to-be-recommended live-streaming room identification based on the history behavior data; and
generating the live-streaming recommendation list based on at least one of the first to-be-recommended live-streaming room identification and the second to-be-recommended live-streaming room identification.

16. The server according to claim 13, wherein the one or more processors, when executing the one or more instructions, are caused to perform:
receiving a live-streaming list acquisition instruction from the target client, and acquiring the live-streaming recommendation list based on the live-streaming list acquisition instruction.

17. The server according to claim 13, wherein the one or more processors, when executing the one or more instructions, are caused to perform:
in a process of playing a video stream corresponding to the first live-streaming room on the target client, acquiring the live-streaming recommendation list comprising an identification of another live-streaming room followed by an account logged in the target client in response to start of live-streaming of the another live-streaming room.

18. The server according to claim 13, wherein the target client is configured to display the live-streaming recommendation list in a preset position in the first live-streaming room, wherein the preset position comprises:
a sidebar position in the first live-streaming room or a notification bar position in the first live-streaming room.

19. The server according to claim 13, wherein the one or more processors, when executing the one or more instructions, are caused to perform:
acquiring the plurality of live-streaming room identifications and live-streaming room information corresponding to each of the live-streaming room identifications; and
generating the live-streaming recommendation list based on the plurality of live-streaming room identifications and the live-streaming room information corresponding to each of the live-streaming room identifications, wherein the live-streaming recommendation list further comprises the live-streaming room information corresponding to each of the live-streaming room identifications.
